(19) United States
(12) Patent Application Publication
(10) Pub. No.: US 2011/0110632 A1
(43) Pub. Date: May 12, 2011

(54) FLAME RETARDANT CABLE

(76) Inventor: OLIVIER PINTO, LYON (FR)

(21) Appl. No.: 12/815,504

(22) Filed: Jun. 15, 2010

Related U.S. Application Data
(63) Continuation of application No. 10/719,698, filed on Nov. 21, 2003, now abandoned.

(30) Foreign Application Priority Data
Nov. 29, 2002 (FR) 02 15065

(51) Int. Cl. G02B 6/44; H01B 3/44

(52) U.S. Cl. 385/100; 174/110 PM

(57) ABSTRACT

The present invention relates to a flame-retardant cable comprising a transmission element, a flammable element, and a flame-retardant coating layer surrounding said flammable element, and made of a material based on a polymer obtained from a polymerizable liquid composition containing at least a precursor for said polymer including functional groups selected from acrylates, methacrylates, epoxies, vinyl ethers, allyl ethers, and oxetanes,

wherein said material includes at least one phosphorous group.

### RELATED APPLICATIONS

This application is a continuation of U.S. patent application Ser. No. 10/719,698, filed on Nov. 21, 2003, which in turn claims the benefit of priority to French Patent Application No. 02 15065, filed on Nov. 29, 2002, the entirety of which are incorporated herein by reference.

The present invention relates to a flame-retardant cable.

### BACKGROUND OF THE INVENTION

In known manner, the acquirers of electrical and/or optical cables for transporting power and/or transmitting information, seek, in the event of a fire, to avoid flame propagating along a cable, even if laid vertically, and to prevent the insulating material that covers the cable core from dripping away when melted at high temperature.

European patent application EP 1 191 547 A1 describes a cable whose insulating layer of polyethylene is coated in an outer layer that is thin, preferably 5 micrometers (μm) to 50 μm thick, and serving to combat fire propagation, for example. The coating is of polyacrylate polymer formed by ultraviolet radiation.

Not all polyacrylate coatings are capable both of retarding degradation of the cable and also of providing a cable which can conserve a degree of operability even when subjected directly to extreme thermal stress such as flame or fire.

Furthermore, it is important for the outer coating also to possess good resistance to abrasion.

### OBJECT AND SUMMARY OF THE INVENTION

The object of the invention is to devise a flame-retardant cable, which is preferably inexpensive, and which is quick and easy to manufacture.

Another object of the invention is to devise such a cable that withstands abrasion.

To this end, the invention provides a flame-retardant cable comprising a transmission element, a flammable element, and a flame-retardant coating layer surrounding said flammable element, and made of a material based on a polymer obtained from a polymerizable liquid composition containing at least a precursor for said polymer including functional groups selected from acrylates, methacrylates, epoxies, vinyl ethers, allyl ethers, and oxetanes,

wherein said material includes at least one phosphorous group.

The phosphorous group(s) provide the flame-retardant properties of the coating of the invention.

In a preferred embodiment, the phosphorous group may be chemically-bonded to said polymer, and in this embodiment, the precursor of said polymer may include at least one phosphorous group.

Advantageously, the material of the invention may be free from halogens, elements which are conventionally used as fire-retarding agents.

According to a characteristic, said flammable element may be selected from one or more of the following elements: an insulating layer; a sheathing layer; a reinforcing element; a tube for protecting optical fibers; a grooved core; a serving string; a tape; and a braid.

When said flammable element is an insulating layer, said insulating layer may be made of a material selected from a halogen-free thermoplastic polymer, and preferably polyethylene which presents good dielectric properties.

By way of example, in the field of telecommunications cables which are often laid vertically in ventilation ducts, polyethylene protected by the flame-retardant coating of the invention can advantageously replace polytetrafluoroethylene (PTFE) or copolymers of tetrafluoroethylene and hexafluoropropylene (fluorinated ethylene propylene copolymer FEP) that are better at withstanding fire, but that present poorer dielectric properties.

The flammable element may include its own flame-retarding mineral fills, but that do not provide it with sufficient protection against fire. In this configuration, the flame-retarding coating reinforces the ability of said element to withstand fire.

In an embodiment of the invention, the transmission element is selected from an optical conductor and an electrical conductor.

In a first embodiment, said flame-retarding coating layer is made by applying said polmerizable liquid composition on said flammable element using a coating technique selected from spraying, dipping, impregnation, and application by means of a brush.

In a second embodiment, said flame-retarding coating layer is formed from a tape impregnated in said polymerizable liquid composition and wound on said flammable element.

Advantageously, said polymerizable liquid composition may contain a reactive diluant including an antiabrasion compound which is preferably of bicyclic structure and contains at least one functional group that is selectively reactive with one of the functional groups of said polymer precursor.

In this way, the coating is not only highly flame-retardant, but also withstands abrasion and presents good thermomechanical properties. In addition, the antiabrasion compound is easily miscible and makes the composition easier to apply.

Said composition may be polymerizable, for example, by actinic radiation (ultraviolet radiation, electrons, gamma rays, etc.).

The polymer precursor (monomer, oligomer) including acrylate functional groups and at least one phosphorous group is sold, for example, by UCB Chemicals under the reference Ebecryl IRR 527.

The number of parts by weight of said antiabrasion compound relative to 100 parts by weight of said composition is preferably less than 95 and preferably lies in the range 10 to 30 in order to conserve the highly fire-retardant nature of the coating.

When said antiabrasion compound contains at least one acrylate functional group, the acrylate equivalent weight of said antiabrasion compound is preferably greater than 80 and is preferably substantially equal to 210.

The term “acrylate equivalent weight” is used to mean the molar mass of the compound relative to the number of acrylate functions per molecule.

Thus, the coating layer presents good mechanical properties, in particular good elasticity (high breaking elongation), and also improved hardness.

Said liquid composition is preferably polymerizable by actinic radiation, and when said actinic radiation is of the ultraviolet type, said composition may include a photoinitiator, the number of parts by weight of said photoinitiator relative to 100 parts by weight of said composition lying in the range 0.1 to 10, and preferably being substantially equal to 3.

Said liquid composition is advantageously polymerizable by UV radiation and may contain:
80 parts by weight of said polymer precursor, said precursor being a halogen-free oligomer;
17 parts by weight of isobornyl acrylate; and
3 parts by weight of a photoinitiator.

### DESCRIPTION OF EXAMPLES

Other characteristics and advantages of the present invention appear from the following description of examples given by way of non-limiting illustration.

Examples 1 and 2 relate to a liquid composition that is polymerizable by radiation of the actinic type for the purpose of making a flame-retardant coating layer of the invention for a power cable, a data cable, or a telecommunications cable.

### Example 1

### Composition No. 1

97 parts by weight of Ebecryl IRR 527 from UCB Chemicals, a halogen-free polyester acrylate oligomer having two acrylate functional groups and phosphorous groups; and
3 parts by weight of the photoinitiator DAROCUR1173 (commercial name) from CIBA.

### Example 2

### Composition No. 2

80 parts by weight of Ebecryl IRR 527;
17 parts by weight of an isobornyl acrylate of bicyclic structure such as Genomer 1121 from RAHN, having an acrylate equivalent weight equal to 208; and
3 parts by weight of DAROCUR1173 (commercial name) photoinitiator.

Table 1 gives the properties of a coating No. 1 made of a material based on a polymer obtained by using ultraviolet radiation to polymerize composition No. 1, and of a coating No. 2 made of a material based on a polymer obtained by using ultraviolet radiation to polymerize composition No. 2.

In these examples, the precursor also contains phosphorous groups and the resulting polymer is chemically bonded to phosphorous groups.

TABLE 1

| | Coating No. 1 | Coating No. 2 |
|---|---|---|
| Breaking stress | 13.4 | 21.4 |
| (MPa) at 25° C. | | |
| Breaking | 46 | 43.1 |
| elongation (%) | | |
| Hardness (Buchholz | <59 | 123 |
| method) | | |

On heating to 60° C., composition No. 1 presents viscosity that is equal to about 17,000 millipascal-seconds (mPa·s). Composition No. 2, which has viscosity of about 1206 mPa·s at 50° C., is easier to apply than composition No. 1 and leads to a coating No. 2 presenting good elasticity and better resistance to abrasion.

The use of an isobornyl acrylate serves to improve the mechanical properties and the abrasion resistance of the coating. In addition, this compound with an acrylate functional group that is reactive with one of the acrylate functional groups of the oligomer makes it possible to achieve complete polymerization using a medium pressure mercury vapor lamp emitting in the ultraviolet and mostly in the wavelength range 200 nanometers (nm) to 400 nm, where such a lamp is sold for example by Fusion delivering power of 200 watts per centimeter (W/cm), with the cable traveling at a speed of 80 meters per minute (m/min), and with exposure taking place in a single pass, even when the coating has a thickness of about 100 μm.

In a variant, one or other of compositions No. 1 and No. 2 may also include pigments, fillers, spreading additives or sliding additives, adhesion promoters, ultraviolet stabilizers, and antioxidants.

Table 2 below gives the results of tests carried out in application of the ISO 4589-2 protocol for determining the oxygen limit index (OLI), the self-extinction time, and the combustion length of five samples, thereby characterizing their flame-retardant properties.

Comparative sample No. 1 comprises a layer of power cable sheathing material made up of an ethylene vinyl acetate (EVA) copolymer including flame-retardant mineral fillers such as aluminum trihydrate Al₂O₃,3H₂O.

Each of samples No. 2 and No. 3 comprises a filled layer of EVA similar to that of sample No. 1, but covered in an outer flame-retardant covering of a material based on a polymer obtained from composition No. 1 of the invention.

Samples Nos. 4 and 5 each comprise a filled EVA layer similar to that of sample No. 1 and covered in an outer flame-retardant coating made of a material based on a polymer obtained from composition No. 2 of the invention.

Because of their outer coatings of the invention, samples Nos. 2, 3, and 5 present an OLI that is 5% greater than that of sample No. 1 (only 1% greater for sample No. 4).

The outer coating of the invention on sample No. 4 presents an OLI that is 1% greater than that of sample No. 1.

TABLE 2

| | Thickness of | | | Combustion |
|---|---|---|---|---|
| Sample | outer coating | OLI | Extinction | length |
| No. | (μm) | (%) | time(s) | (mm) |
| 1 | — | 32 | >120 | 10 |
| 2 | 40 | 37 | 175 | 35 |
| 3 | 70 | 37 | 170 | 35 |
| 4 | 50 | 33 | 58 | 5 |
| 5 | 100 | 37 | 103 | 10 |

The use of isobornyl acrylate requires the thickness of the coating to be increased in order to obtain an OLI of 37%. Nevertheless, from tests performed on sample No. 5, it is observed that this compound makes it possible not only to improve the mechanical properties and abrasion resistance of the coating, but also to reduce its combustion length and to shorten its extinction time.

Table 3 below gives the results of tests performed on three vertical cables, the tests being carried out using the IEC 3321 protocol. The test consists in subjecting a cable or an insulator conductor in the vertical position to a flame fed with a mixture of air and propane at respective flow rates of 4 liters per minute (l/min) and 640 milliliters per minute (ml/min) coming from a burner that is positioned at an angle of 45° relative to the vertical axis of the sample and applied for a duration of 60 seconds, and then determining extinction time and combustion length.

Cable No. 1 comprises a copper conductor having a section of 16 square millimeters (mm²) coated in a flammable insulating layer made of a compound containing polyethylene cross-linked by the silane process and not containing any flame-retardant mineral fillers.

Cables No. 2 and No. 3 both comprise a coated copper conductor similar to the conductor of cable No. 1, each coated in an insulating layer similar to the layer of cable No. 1, said layer in turn being coated in an outer layer of flame-retardant coating made of a material based on a polymer obtained from composition No. 1 in one case and composition No. 2 in the other.

Polymerization was obtained by means of a 200 W/cm ultraviolet lamp and the cable travel speed was 50 m/min.

TABLE 3

| | Thickness of | | Combustion |
|---|---|---|---|
| Cable | outer coating | Extinction | length |
| No. | (μm) | time | (mm) |
| 1 | — | >4′ | 440 |
| 2 | 41 | 2′28″ | 135 |
| 3 | 100 | 2′26″ | 95 |

A cable passes the test if the combustion distance above the zone in which the flame was applied does not exceed 425 mm. As expected, cable No. 1 does not pass the test. Furthermore, the combustion length of cable No. 3 is shorter than that of cable No. 2.

FIG. 1 is a cross-section view of a power cable of the invention.

The cable 1 comprises, by way of example, a transmission element 2 such as an electrical conductor, e.g. made of copper, coated in a flammable insulating layer 3 itself coated in a layer 4 of flame-retardant coating made of a material based on a polymer obtained, for example, from composition No. 2 and of thickness that is preferably equal to about 100 μm.

The layer 4 of the invention is an outer coating layer on the insulating layer, since it provides flame-retardant properties and preferably also resistance to abrasion. Nevertheless, the cable 1 could naturally include one or more other layers between the insulating layer and the layer 4 of the invention.

The flame-retardant coating layer is made by applying the polymerizable liquid composition on the flammable insulating layer using a conventional coating technique, e.g. application by means of a brush or by spraying.

In a variant, the flame-retardant coating layer is made from a tape impregnated in the composition and wound on the flammable insulating layer.

The invention is equally applicable to any flammable element used in the manufacture of a telecommunications or a power cable, for example a reinforcing element, an optical fiber protection tube, a padding element, a grooved core, or a braid.

More generally, the invention is equally applicable to power cables and to telecommunications cables, to data cables, to electrical cables, and to optical fiber cables.

What is claimed is:

1. A flame-retardant cable comprising:
a transmission element;
a flammable element; and
a flame-retardant coating layer of cross-linkable resin surrounding said flammable element, wherein said flame-retardant layer includes a polymer obtained from a polymerizable liquid composition, and wherein said polymerizable liquid composition contains at least
a precursor for said polymer, the precursor including a functional group and at least one phosphorus group, said function group being selected from the group consisting of acrylates, methacrylates, epoxies, vinyl ethers, allyl ethers, and oxetanes, such that said at least one phosphorous group as an additional precursor such that said phosphorus group is chemically bonded within said polymer chain after polymerization.

2. A flame-retardant cable according to claim 1, wherein said phosphorous group is chemically bonded to said polymer.

3. A flame-retardant cable according to claim 1, wherein the precursor of said polymer includes at least one phosphorous group.

4. A flame-retardant cable according to claim 1, wherein said material is halogen-free.

5. A flame-retardant cable according to claim 1, wherein said flammable element is selected from the group consisting of the following elements: an insulating layer; a sheathing layer; a reinforcing element; an optical fiber protection; a padding element; a groove core; a tape; and a braid.

6. A flame-retardant cable according to claim 1, wherein, when said flammable element is an insulating layer, said insulating layer is made from a material selected from a halogen-free thermoplastic polymer.

7. A flame-retardant cable according to claim 1, wherein the transmission element is selected from a conductor of light and a conductor of electricity.

8. A flame-retardant cable according to claim 1, wherein said flame-retardant coating layer is made by applying said polymerizable liquid composition on said flammable element using a coating technique selected from the group consisting of spraying, dipping, impregnation, and application by means of a brush.

9. A flame-retardant cable according to claim 1, wherein said flame-retardant coating layer is made from a tape impregnated in said polymerizable liquid composition and wound on said flammable element.

10. A flame-retardant cable according to claim 1, wherein said polymerizable liquid composition contains a reactive diluent including an antiabrasion compound containing at least one functional group that is selectively reactive with one of the functional groups of said polymer precursor.

11. A flame-retardant cable according to claim 10, wherein the number of parts by weight of said antiabrasion compound relative to 100 parts by weight of said liquid composition is less than 95.

12. A flame-retardant cable according to claim 10, wherein, when said antiabrasion compound contains at least one acrylate functional group, the acrylate equivalent weight of said antiabrasion compound is greater than 80.

13. A flame-retardant cable according to claim 1, wherein the liquid composition is polymerizable by actinic radiation, and when said actinic radiation is of the UV type, the composition includes a photoinitiator.

14. A flame-retardant cable according to claim 13, wherein the number of parts by weight of said photoinitiator relative to 100 parts by weight of said composition lies in the range 0.1 to 10.

15. A flame-retardant cable according to claim 1, wherein the liquid composition is polymerizable by UV radiation and contains:
80 parts by weight of said polymer precursor, said precursor being a halogen-free oligomer;
17 parts by weight of an isobornyl acrylate; and
3 parts by weight of a photoinitiator.

16. A flame-retardant cable according to claim 11, wherein the number of parts by weight of said antiabrasion compound relative to 100 parts by weight of said liquid composition is in the range 10 to 30.

17. A flame-retardant cable according to claim 12, wherein, when said antiabrasion compound contains at least one acrylate functional group, the acrylate equivalent weight of said antiabrasion compound is about 210.

18. A flame-retardant cable according to claim 14, wherein the number of parts by weight of said photoinitiator relative to 100 parts by weight of said composition is about 3.

19. A flame-retardant cable according to claim 6, wherein said insulating layer is made from polyethylene.

20. A flame-retardant cable according to claim 10, wherein said antiabrasion compound is of a bicyclic structure.

21. A flame-retardant cable comprising:
a transmission element;
a flammable element; and
a flame-retardant coating layer of cross-linkable resin surrounding said flammable element, wherein said flame-retardant layer includes a polymer obtained from a polymerizable liquid composition, and wherein said polymerizable liquid composition contains at least first and second precursors for said polymer, said first precursor including functional groups selected from the group consisting of acrylates, methacrylates, epoxies, vinyl ethers, allyl ethers, and oxetanes, and
said second precursor including at least one phosphorous group such that said polymerization of said polymerizable liquid composition into said polymer results in said phosphorus group being chemically bonded within said polymer chain after polymerization.
